(19) United States
(12) Patent Application Publication
(10) Pub. No.: US 2007/0246272 A1
(43) Pub. Date: Oct. 25, 2007

(54) Control device for a hybrid electric vehicle

(76) Inventor: Makoto Ogata, Kanagawa (JP)

Correspondence Address: JACOBSON HOLMAN PLLC, 400 SEVENTH STREET N.W., SUITE 600, WASHINGTON, DC, 20004, US

(21) Appl. No.: 11/713,621

(22) Filed: Mar. 5, 2007

(30) Foreign Application Priority Data
Mar. 3, 2006 (JP) 2006-057649

(51) Int. Cl. B60K 6/02

(52) U.S. Cl. 180/65.2; 903/903

(57) ABSTRACT

In a hybrid electric vehicle, in the event that the driving force of the engine is transmitted to the driving wheels, when a required torque according to an operating state of the vehicle is smaller than an allowable torque, an ECU controls the engine to output the required torque by the engine alone. On the other hand, when the required torque is greater than the allowable torque, the ECU controls the engine so that the engine outputs the allowable torque and controls the motor so that the motor outputs the torque equal to deficiency of the allowable torque with respect to the required torque. The ECU increases the allowable torque in a low revolution region and decreases the allowable torque in a high revolution region in the case in which regeneration of a filter is performed as compared to the case in which the regeneration is not performed.

### BACKGROUND OF THE INVENTION

1. Field of the Invention

The present invention relates to a control device of a hybrid electric vehicle, and more specifically, to a control device for a hybrid electric vehicle arranged such that both a driving force of an engine and a driving force of an electric motor can be transmitted to driving wheels of the vehicle.

2. Description of the Related Art

Conventionally, a so-called parallel type hybrid electric vehicle capable of transmitting a driving force of an engine and a driving force of an electric motor to driving wheels of the vehicle, respectively, has been developed and put to practical use.

This kind of parallel type hybrid electric vehicle is proposed by, for example, Japanese Unexamined Patent Publication No. 2005-120887 (hereinafter referred to Patent Document 1). This hybrid electric vehicle comprises a clutch for mechanically connecting/disconnecting the engine and an automatic transmission, and a rotary shaft of the electric motor is connected between the output shaft of the clutch and the input shaft of the automatic transmission.

In the hybrid electric vehicle as shown in the Patent Document 1, change-over is selectively performed between the condition where the clutch is engaged so that the driving force can be transmitted to the driving wheels from both the engine and the electric motor and the condition where the clutch is disengaged so that the driving force of the electric motor alone can be transmitted to the driving wheels.

In deceleration of the vehicle, the electric motor is operated as a generator to generate a regenerative braking force, and kinetic energy of the driving wheels is converted to electric power energy to be recovered in a battery, thereby improving the energy efficiency.

The engine carried by the hybrid electric vehicle of the Patent Document 1 is a diesel engine, and particulate matter is contained in exhaust of the diesel engine. Consequently, a particulate filter for collecting the particulate matter (hereinafter called the “filter”) is disposed in an exhaust passage of the engine to prevent the particulate matter from being discharged into the atmosphere. When the collected particulate matter continues to be accumulated in the filter, clogging occurs in the filter. In order to prevent such clogging, when the amount of the accumulated particulate matter increases, exhaust temperature of the engine is raised to incinerate the particulate matter in the filter, thereby regenerating the filter.

However, in the event that the hybrid electric vehicle travels at a low speed while using together the driving force of the engine and the driving force of the electric motor, the condition of low engine torque continues and the exhaust temperature lowers. This makes it difficult to raise the exhaust temperature to the temperature where the filter can be regenerated. Consequently, there occurs a problem in that it takes long time in regenerating the filter to increase fuel consumption and thereby fuel economy degrades. In addition, this gives rise to another problem in that the particulate matter in the filter is unable to be successfully incinerated and filter clogging results.

Therefore, in the hybrid electric vehicle of Patent Document 1, the ratio of an output torque of the engine that accounts for a required torque necessary for vehicle traveling at the time of such low-speed traveling is increased to raise the exhaust temperature of the engine, and thereby the filter can be properly regenerated even at the time of low-speed traveling.

However, as is the case of the hybrid electric vehicle of Patent Document 1, if the ratio of the output torque of the engine in the low-revolution region of the engine is increased when both a driving force of the engine and a driving force of the electric motor are used in combination and the filter is regenerated, the ratio of an output torque of the electric motor is decreased and power consumption of the battery by the electric motor is decreased.

Consequently, the chance to discharge the energy recovered in a battery by regenerative braking at the time of vehicle deceleration decreases. As a result, the storage rate of the battery increases and it becomes difficult to maintain the storage rate within the allowable range where battery deterioration does not occur. This may promote battery deterioration.

### SUMMARY OF THE INVENTION

An aspect of the present invention is directed to a control device for a hybrid electric vehicle arranged such that a driving force of an engine and a driving force of an electric motor can be transmitted to driving wheels, and that the engine and the electric motor are controlled on the basis of a required torque determined in accordance with an operating condition of the vehicle, comprising a filter that collects particulate matter contained in exhaust of the engine; a regeneration means for incinerating the particulate matter collected and accumulated in the filter to regenerate the filter; and a control means which, in the event that the driving force of the engine is transmitted to the driving wheels, controls the engine so that the required torque is outputted by the engine alone when the required torque is equal to or smaller than a predetermined allowable torque; and, on the other hand, controls the engine so that the engine outputs the allowable torque and, at the same time, controls the electric motor so that the electric motor outputs a torque equal to deficiency of the allowable torque with respect to the required torque when the required torque is greater than the allowable torque, wherein: the control means increases the allowable torque in a lower revolution region of the engine, if the regeneration of the filter is carried out by the regeneration means, as compared to that when the regeneration of the filter is not carried out by the regeneration means, and decreases the allowable torque in a high revolution region of the engine.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a diagram showing a schematic structure of a hybrid electric vehicle having a control device according to one embodiment of the present invention;

FIG. 2 is a diagram showing a control map used when regeneration of a filter is not performed in the hybrid electric vehicle of FIG. 1; and

FIG. 3 is a diagram showing a control map used when regeneration of a filter is performed in the hybrid electric vehicle of FIG. 1.

### DETAILED DESCRIPTION OF THE INVENTION

Referring now to drawings, one embodiment of the present invention will be described below.

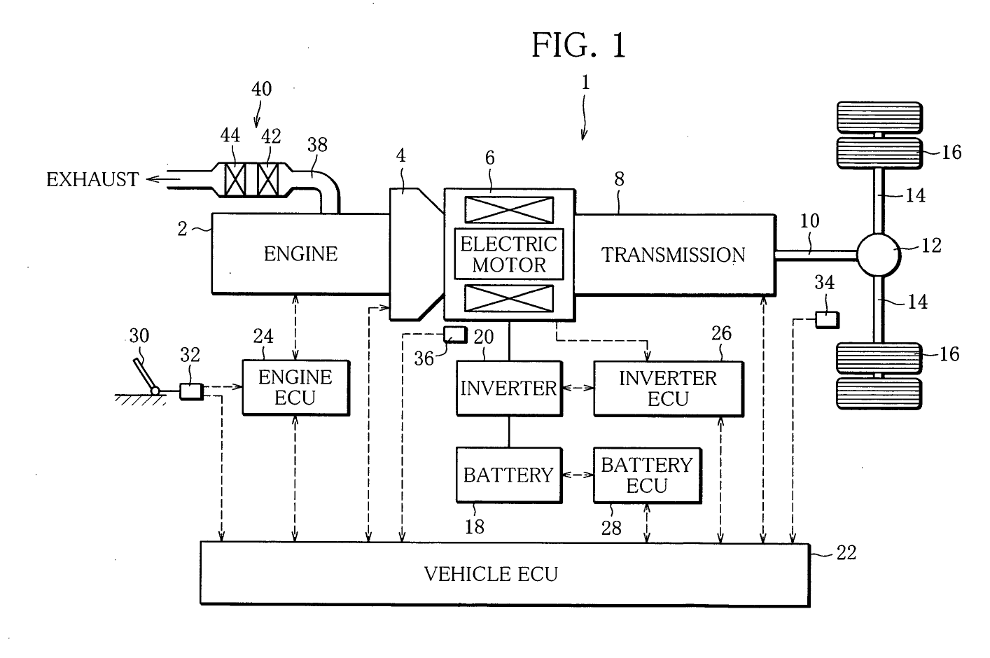

FIG. 1 is a diagram showing the schematic structure of a hybrid electric vehicle 1 to which the present invention is applied.

An input shaft of a clutch 4 is coupled to an output shaft of an engine 2, which is a diesel engine. An output shaft of the clutch 4 is coupled to an input shaft of an automatic transmission (hereinafter, referred to as transmission) 8 through a rotary shaft of a permanent-magnetic synchronous motor (hereinafter, referred to as electric motor) 6. An output shaft of the transmission 8 is connected to left and right driving wheels 16 through a propeller shaft 10, a differential gear unit 12 and driving shafts 14.

When the clutch 4 is engaged, both the output shaft of engine 2 and the rotary shaft of the electric motor 6 can be mechanically connected with the driving wheels 16. When the clutch 4 is disengaged, only the rotary shaft of the electric motor 6 can be mechanically connected with the driving wheels 16.

The electric motor 6 is operated as a motor when DC power stored in a battery 18 is supplied to the electric motor 6 after being converted into AC power by an inverter 20. A driving torque of the electric motor 6 is transmitted to the driving wheels 16 after being shifted to a proper speed by the transmission 8. At the time of deceleration of the vehicle, the electric motor 6 is operated as a generator. Kinetic energy created by the revolution of the driving wheels 16 is transmitted to the electric motor 6 through the transmission 8 to be converted into AC power, thereby generating a decelerating torque based on a regenerative braking force. This AC power is converted into DC power by the inverter 20 and is then charged to the battery 18. In this manner, the kinetic energy created by the revolution of the driving wheels 16 is recovered as electrical energy.

On the other hand, when the clutch 4 is engaged, a driving torque of the engine 2 is transmitted to the transmission 8 through the rotary shaft of the electric motor 6. After being shifted to a proper speed, the driving torque of the engine 2 is transmitted to the driving wheels 16. Accordingly, if the electric motor 6 is operated as a motor while the driving torque of the engine 2 is transmitted to the driving wheels 16, both the driving torque of the engine 2 and the driving torque of the electric motor 6 are transmitted to the driving wheels 16. That is, a part of the driving torque to be transmitted to the driving wheels 16 for driving vehicles is supplied from the engine 2, and at the same time, the rest of the driving torque is supplied from the electric motor 6.

If a storage rate (hereinafter, referred to as SOC) of the battery 18 lowers, and the battery 18 then needs be charged, the electric motor 6 is operated as a generator. Moreover, the electric motor 6 is driven by using a part of the driving torque of the engine 2, to thereby carry out electric power generation. The AC power thus generated is converted into DC power by the inverter 20, and the battery 18 is charged with this DC power.

A vehicle ECU 22 (control means) implements engagement/disengagement control of the clutch 4 and gear shift control of the transmission 8 in accordance with an operating state of the vehicle, an operating state of the engine 2, and information from an engine ECU (regeneration means) 24, an inverter ECU 26, a battery ECU 28, etc. The vehicle ECU 22 also performs integrated control for properly controlling the engine 2 and the electric motor 6 in accordance with state of the above-mentioned controls, and the various kinds of states, such as start, acceleration, deceleration of the vehicle.

The hybrid electric vehicle 1 is provided with an accelerator opening sensor 32 for detecting the depression amount of an accelerator pedal 30, a vehicle speed sensor 34 for detecting the traveling speed of the vehicle, and a revolution speed sensor 36 for detecting the revolution speed of the electric motor 6. When performing the above-mentioned controls, the vehicle ECU 22 calculates a required torque necessary for traveling of the vehicle based on the detection results supplied from the accelerator opening sensor 32, the vehicle speed sensor 34 and revolution speed sensor 36. Furthermore, the vehicle ECU 22 sets a torque to be generated by the engine 2 and a torque to be generated by the electric motor 6, on the basis of the required torque.

It is to be noted that the revolution speed of the electric motor 6 detected by the revolution speed sensor 36 coincides with the revolution speed of the engine 2 when the clutch 4 is engaged.

The engine ECU 24 performs various kinds of controls required for the operation of the engine 2 per se, including start/stop control and idling control of the engine 2. In addition, the engine ECU 24 controls fuel injection quantity, fuel injection timing, etc. for the engine 2 so that the engine 2 generates the torque required in the engine 2, which has been set by the vehicle ECU 22.

The inverter ECU 26 controls the inverter 20 based on the torque to be generated by the electric motor 6, which has been set by the vehicle ECU 22, and thereby controls the electric motor 6 to be operated as a motor or as a generator.

The battery ECU 28 detects temperature of the battery 18, a voltage of the battery 18, a current flowing between the inverter 20 and the battery 18, etc. The battery ECU 28 obtains an SOC of the battery 18 from these detection results, and transmits the obtained SOC to the vehicle ECU 22, together with the detection results.

The engine 2 is provided with an exhaust after-treatment device 40, which purify exhaust of the engine 2, in an exhaust passage 38 of the engine 2. In the exhaust after-treatment device 40, an oxidation catalyst 42 is disposed, and a particulate filter (hereinafter, referred to as filter) 44 is disposed downstream of the oxidation catalyst 42.

The filter 44 is composed with a honeycomb type ceramic carrier. In the filter 44, a large number of passages communicating between the upstream side and the downstream side are laid side by side. The upstream-side opening and the downstream-side opening of each of the passages are closed alternately and the filter 44 purifies exhaust of the engine 2 by collecting particulate matter contained in the exhaust of the engine 2.

The oxidation catalyst 42 oxidizes and purifies CO (carbon monoxide) and HC (hydrocarbon) contained in the exhaust of the engine 2. Furthermore, when the volume of the particulate accumulated in the filter 44 increases and regeneration of the filter 44 is required, the oxidation catalyst 42 has a function to oxidize HC supplied in the exhaust passage 38 of the engine 2 to raise temperature of the exhaust flowing into the filter 44.

A control for regenerating the filter 44 is performed by the engine ECU 24 as follows:

The engine ECU 24 starts a regeneration control for the filter 44, when the engine ECU 24 judges that the volume of the particulate matter accumulated in the filter 44 is equal to or larger than a predetermined volume based on the exhaust pressure difference before and after the filter 44, etc., the engine ECU 24 starts the regeneration control of the filter 44.

In order to regenerate the filter 44, it is necessary to oxidize HC in the exhaust by the oxidation catalyst 42 to raise the temperature of the exhaust flowing into the filter 44 as described above. When the exhaust temperature of the engine 2 is not satisfactorily raised to an activation temperature (for example, 250° C.) at which HC can be oxidized by the oxidation catalyst 42, the engine ECU 24 raise the exhaust temperature by carrying out an additional fuel injection in the expansion stroke of the engine 2 separately from the main fuel injection into the combustion chamber of the engine 2 and combusting the fuel in an exhaust port or an exhaust manifold (neither one is shown) of the engine 2, or by reducing intake air of the engine 2.

When the exhaust temperature reaches a temperature at which HC can be oxidized by the oxidation catalyst 42, the engine ECU 24 carries out a post injection in the exhaust stroke separately from the main fuel injection. Alternatively, in the case where the exhaust passage 38 is provided with a fuel adding valve (not shown), the engine ECU 24 control the fuel adding valve to inject fuel from the fuel adding valve into the exhaust passage 38 to supply HC to the exhaust of the engine 2. HC supplied into the exhaust is oxidized by the oxidation catalyst 42 to raise the exhaust temperature. As a result, the temperature of the exhaust flowing into the filter 44 rises to a temperature (for example, 600° C.) at which particulate matter can be burned. Consequently, the particulate matter accumulated in the filter 44 is incinerated, and the filter 44 is regenerated.

When the pressure difference before and after the filter 44 is lowered by incinerating the particulate matter in the filter 44, the engine ECU 24 judges that the regeneration of the filter 44 is completed and ends the regeneration control.

The outline of controls performed mainly by the vehicle ECU 22, in the hybrid electric vehicle 1 arranged as described above, in order to make the vehicle travel is as follows:

First of all, it is assumed that the vehicle is at rest with the engine 2 stopped. When a driver operates a starter switch (not shown) to start the engine 2, with a shift change lever (not shown) in the neutral position, the vehicle ECU 22 confirms that the transmission 8 is in the neutral position so that the electric motor 6 and the driving wheels 16 are mechanically disconnected, and that the clutch 4 is engaged. Then the vehicle ECU 22 indicates to the inverter ECU 26 a driving torque of the electric motor 6 required for starting the engine 2, and commands the engine ECU 24 to operate the engine 2.

The inverter ECU 26 operates the electric motor 6 as a motor to generate a driving torque on the basis of the indication from the vehicle ECU 22, thereby cranking the engine 2. At this time, the engine ECU 24 starts fuel supply to the engine 2, thereby causing the engine 2 to start. After starting the engine 2, the engine 2 carries out idling operation.

When the driver operates the shift change lever to a drive position or the like, the vehicle ECU 22 disengage the clutch 4 and changes the speed change position of the transmission 8 from the neutral position to a position for starting (for example, a position for the first gear, the second gear, or the reverse gear of the transmission 8).

When the driver steps on the accelerator pedal 30 in this condition, the vehicle ECU 22 sets a required torque to be transmitted to the transmission 8 in order to start and to allow the vehicle to travel in accordance with the depression amount of the accelerator pedal 30 detected by the accelerator opening sensor 32. The vehicle ECU 22 sets a driving torque to be outputted from the engine 2 and the electric motor 6 respectively on the basis of the required torque and the revolution speed of the electric motor 6 detected by the revolution speed sensor 36, by means of a control map stored in advance. In such event, the vehicle ECU 22 controls the clutch 4 and transmission 8 as required.

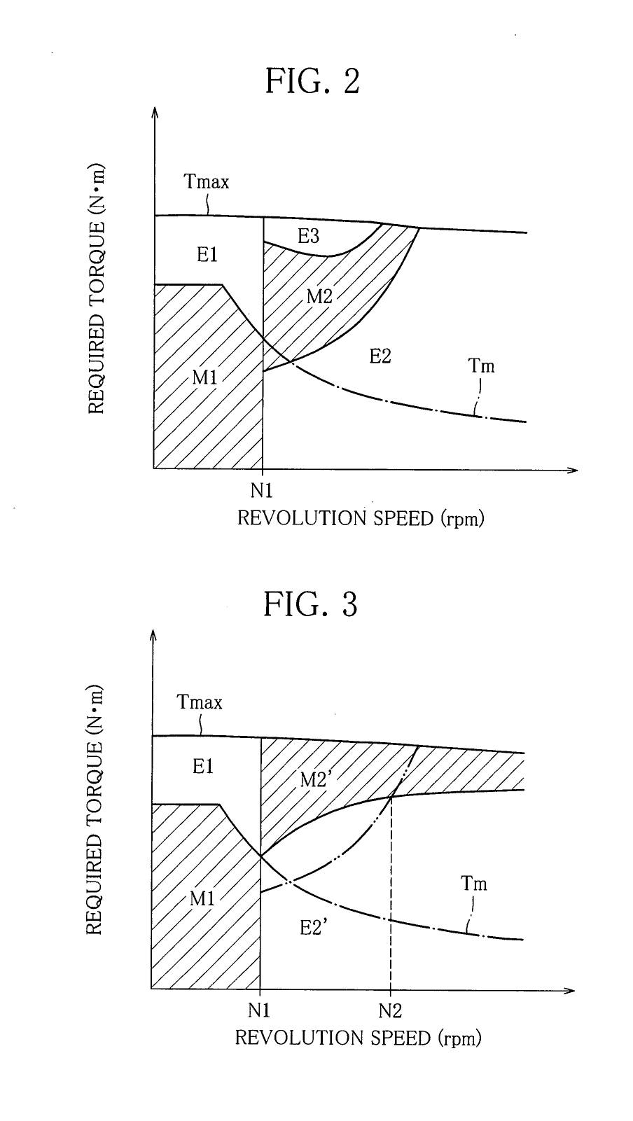

The control map which the vehicle ECU 22 uses in the above-mentioned control differs between the case of performing regeneration of the filter 44 and the case of not performing the regeneration. FIG. 2 shows the control map when the regeneration of the filter 44 is not performed, while FIG. 3 shows the control map when the regeneration of the filter 44 is performed, respectively.

It is to be noted, when condition is changed over from the condition in which the regeneration of the filter 44 is not performed to the condition in which the regeneration of the filter 44 is performed or vice versa, the vehicle ECU 22 does not change over directly from one control map to another control map of the control maps of FIG. 2 and FIG. 3. In this case, during a predetermined transition period, the vehicle ECU 22 gradually changes over the control map while performing an interpolating process in such a manner that a control variable between the control variable read from one control map and the control variable read from another control map can be obtained.

The control map for the case where the regeneration of the filter 44 is not performed is defined by the revolution speed of the electric motor 6 and the required torque as shown in FIG. 2. This control map is divided into several control regions as shown with solid line in the drawing in the region below the upper limit value Tmax of the required torque.

It is to be noted that, in FIG. 2, the revolution speed Ni nearly coincides with the idling speed of the engine 2 and is, for example, 650 rpm.

The chain line in FIG. 2 indicates the upper limit torque Tm which the electric motor 6 can output at each revolution speed. This upper limit torque Tm overlaps the solid line which indicates the boundary of the region in the low revolution region lower than the revolution speed N1 as shown in FIG. 2. Because the upper limit torque Tm can be changed in accordance with the parameters such as the temperature of the electric motor 6, the temperature of the battery 18, the SOC of the battery 18, etc., the boundary in the control map is variable.

In such control map, the control region below the revolution speed N1 is divided into two regions of M1 and E1, with the curve that indicates the upper limit torque Tm of the electric motor 6 set as a boundary. When the required torque is located within the region M1, the clutch 4 is disengaged and only the output torque of the electric motor 6 is transmitted to the transmission 8, because the revolution speed of the electric motor 6 is lower than the idling speed of the engine 2 and the electric motor 6 can singly output the required torque.

When the required torque is located within the region E1, the required torque can not be obtained only with the upper limit torque Tm. Consequently, the vehicle ECU 22 causes the electric motor 6 to output the upper limit torque Tm corresponding to the present revolution speed, and at the same time, causes the engine 2 to output the torque equal to the deficiency of the upper limit torque Tm with respect to the required torque. In such event, the vehicle ECU 22 partially engages the clutch 4 so that the revolution speed of the engine 2 does not come down below the idling speed of the engine 2.

The control region in which the revolution speed is equal to or higher than the revolution speed N1 is divided into three regions, namely, E2, M2, and E3. The border line between the region E2 and the region M2 corresponds to the allowable torque which is set to be smaller than the maximum torque Te (not shown) which the engine 2 can output. Such allowable torque is set so that the output torque of the engine 2 is retained to a region with comparatively low NOx emissions because NOx emissions of the engine 2 generally tend to increase in the region with high output torque.

In the event that the required torque is located in such region E2, the vehicle ECU 22 engages the clutch 4 and sets the output torque of the electric motor 6 to 0 N·m. At the same time, the vehicle ECU 22 controls the engine 2 in such a manner that the required torque is outputted only by the engine 2.

The region M2 can be obtained by extending the region M2 with the upper limit torque Tm of the electric motor 6. When the required torque is located in the region M2, the vehicle ECU 22 engages the clutch 4. Then, the vehicle ECU 22 causes the engine 2 to output the allowable torque, and causes the electric motor 6 to output the torque equal to the deficiency of the output torque of the engine 2 with respect to the required torque.

In the region E3, the required torque can not be obtained only from the sum of the allowable torque outputted from the engine 2 and the upper limit torque Tm outputted from the electric motor 6. In limited cases such as rapid acceleration of the vehicle, climbing slopes, etc., the required torque may be included in this kind of region. When the required torque is located in the region E3, the vehicle ECU 22 engages the clutch 4. Then the vehicle ECU 22 causes the electric motor 6 to output the upper limit torque Tm and increases the engine output torque from the allowable torque so that the sum of the output torque of the engine 2 and the output torque of the electric motor 6 is equal to the required torque.

The controls of the engine 2 and the electric motor 6 with the above-described control maps are as follows:

First of all, because the revolution speed of the electric motor 6 is 0 rpm with the vehicle stopped, the control region applied at starting of the vehicle is a low revolution region below the revolution speed N1. When the point which is defined by the required torque set in accordance with the depression amount of the accelerator pedal 30 and the revolution speed of the electric motor 6 detected by the revolution speed sensor 36 is included in the region M1, the vehicle ECU 22 disengages the clutch 4 and commands the inverter ECU 26 so that the output torque of the electric motor 6 is equal to the required torque.

The inverter ECU 26 controls the inverter 20 in accordance with the required torque set by the vehicle ECU 22. As a result, the DC power of the battery 18 is supplied to the electric motor 6 after being converted into the AC power by the inverter 20. The AC power is supplied to the electric motor 6, and the electric motor 6 is operated as a motor to output the required torque. The output torque of the electric motor 6 is transmitted to the driving wheels 16 through the transmission 8 and thereby the vehicle starts traveling.

On the other hand, when the point which is defined by the required torque set in accordance with the depression amount of the accelerator pedal 30 and the revolution speed of the electric motor 6 is included in the region E1, the vehicle ECU 22 commands the inverter ECU 26 so that the upper limit torque Tm is outputted from the electric motor 6 and commands the engine ECU 24 so that the torque equal to the deficiency of the upper limit torque Tm with respect to the required torque is outputted from the engine 2.

In such event, the vehicle ECU 22 partially engages the clutch 4, because the revolution speed of the electric motor 6 is lower than the revolution speed N1 set to nearly coincide with the idling speed of the engine 2. Then the vehicle ECU 22 commands the engine ECU 24 so that the engine 2 outputs the torque which makes the torque transmitted from the clutch 4 to the transmission 8 equal to the deficiency.

The inverter ECU 26 controls the inverter 20 as described above in accordance with the commands from the vehicle ECU 22 and the electric motor 6 is operated as a motor to output the upper limit torque Tm.

At the same time, the engine ECU 24 controls the engine 2 so that the engine 2 outputs the torque directed by the vehicle ECU 22. As a result, the sum of the output torque from the engine 2 and the output torque from the electric motor 6 which is equal to the required torque, is transmitted to the transmission 8 and thereby the vehicle starts traveling.

In this way, when the vehicle starts traveling, the vehicle ECU 22 preferentially uses the electric motor 6 and causes the electric motor 6 to output up to the upper limit torque Tm. By so doing, the use ratio of the engine 2 with comparatively poor operation efficiency in the low revolution region can be reduced and thereby the fuel economy can be improved. Furthermore, by using the electric motor 6, the vehicle can start traveling smoothly.

In the event that the required torque can not be obtained only from the output torque of the electric motor 6, the required torque is obtained by using the output torque of the engine 2 in combination. Consequently, shortage of torque does not occur at starting of the vehicle and thereby satisfactory operating performance of the vehicle can be secured.

When the vehicle enters a traveling condition after starting and acceleration in this way, the vehicle ECU 22 sets the required torque necessary for the traveling of the vehicle on the basis of the depression amount of the accelerator pedal 30 detected by the accelerator pedal opening sensor 32 and the traveling speed detected by the vehicle speed sensor 34.

When the revolution speed of the electric motor 6 rises and enters the region above the revolution speed N1, the vehicle ECU 22 changes over the control depending on which region of E2, M2, or E3 the point defined by the revolution speed of the electric motor 6 detected by the revolution speed sensor 36 and the required torque is located in.

In the event that the point defined by the revolution speed of the electric motor 6 and the required torque is located in the region E2, the vehicle ECU 22 engages the clutch 4 and commands the inverter ECU 26 to bring the output torque of the electric motor 6 to 0 N·m. Furthermore, the vehicle ECU 22 commands the engine ECU 24 so that the required torque is outputted from the engine 2.

The inverter ECU 26 controls the inverter 20 to bring the output torque of the electric motor 6 to 0 N·m by operating the electric motor 6 neither as a motor nor as a generator. On the other hand, the engine ECU 24 controls the engine 2 to output the required torque and thereby the required torque outputted from the engine 2 is transmitted to the transmission 8.

In the event that the point which is defined by the revolution speed of the electric motor 6 and the required torque is located in the region M2, the vehicle ECU 22 engages the clutch 4. At the same time, the vehicle ECU 22 commands the engine ECU 24 so that the output torque of the engine 2 is equal to the allowable torque, and commands the inverter ECU 26 so that the electric motor 6 outputs the torque equal to the deficiency of the output torque of the engine 2 with respect to the required torque.

The engine ECU 24 controls the engine 2 in such a manner that the output torque of the engine 2 is equal to the allowable torque. At the same time, the inverter ECU 26 controls the inverter 20 so that the electric motor 6 is operated as a motor and the output torque of the electric motor 6 is equal to the torque directed by the vehicle ECU 22. As a result, the sum of the output torque of the engine 2 and the output torque of the electric motor 6, which is equal to the required torque, is transmitted to the transmission 8.

In this way, in the region in which the revolution speed of the electric motor 6 is higher than N1, the engine 2 is operated in a region with comparatively low NOx emissions because the output torque of the engine 2 is restricted to the allowable torque or smaller.

Furthermore, the output torque of the electric motor 6 compensates the deficiency from the required torque, which is caused by restricting the output torque of the engine 2 to the allowable torque. By so doing, the required torque necessary for vehicle traveling is transmitted to the transmission 8. Consequently, satisfactory operating performance of the vehicle can be secured without generating any torque deficiency.

In the event that the point defined by the revolution speed of the electric motor 6 and the required torque is located in the region E3, the vehicle ECU 22 engages the clutch 4, and commands the inverter ECU 26 so that the upper limit torque TM is outputted from the electric motor 6. At the same time, the vehicle ECU 22 commands the engine ECU 24 so that the engine 2 outputs the torque which makes the sum of the output torque of the engine 2 and the output torque of the electric motor 6 equal to the required torque. Consequently, the output torque of the engine 2 directed by the engine ECU 24 is greater than the allowable torque.

The inverter ECU 26 controls the inverter 20 so that the electric motor 6 is operated as a motor to output the upper limit torque Tm. At the same time, the engine ECU 24 controls the engine 2 so that the engine 2 outputs the torque directed by the vehicle ECU 22. As a result, the sum of the output torque of the engine 2 and the output torque of the electric motor 6, which is equal to the required torque, is transmitted to the transmission 8.

By carrying out the above-described control, the required torque can be securely transmitted to the transmission 8 even if a large required torque is temporarily required at the time of rapid acceleration of the vehicle, climbing a slope, etc. Consequently, satisfactory operating performance of the vehicle can be secured without causing torque deficiency.

As described above, in the event that the regeneration of the filter 44 is not carried out, in the region in which the revolution speed of the electric motor 6 is higher than N1, that is, when the clutch 4 is engaged and the driving force of the engine 2 can be transmitted to the driving wheels 16, the output torque of the engine 2 is restricted to a level equal to or lower than the allowable torque, except for the cases where a large required torque is temporarily required at the time of rapid acceleration of the vehicle, climbing a slope, or the like.

As shown in FIG. 2, in the region closer to the revolution speed N1, that is, in the low revolution region of the engine 2, the output torque of the engine 2 is greatly restricted. Consequently, in the event that regeneration of the filter 44 is required, in order to achieve the regeneration of the filter 44, the exhaust temperature must be raised to the temperature at which HC in the exhaust can be oxidized by the oxidation catalyst 42 as described before. However, in the low rotation region of the engine 2, the exhaust temperature of the engine 2 is low and it takes time to complete the regeneration. As a result, additional fuel is used and the fuel economy is degraded.

Therefore, in the present embodiment, in the event that regeneration of the filter 44 is required, the vehicle ECU 22 uses the control map of FIG. 3 in place of the control map of FIG. 2.

The control map of FIG. 3 is defined by the revolution speed of the electric motor 6 and the required torque as is the case of the control map of FIG. 2, too, and it is divided into several control regions as shown in solid lines in the figure in the region below the upper limit value Tmax of the required torque.

Furthermore, the chain line in FIG. 3 shows the upper limit torque Tm which the electric motor 6 can output at each revolution speed as is the case of FIG. 2, and in the region below the revolution speed N1, it overlaps the solid line which indicates the boundary of the regions.

In such control map, the region below the revolution speed N1 has the configuration identical to that of the control map of FIG. 2. Consequently, in this region, the vehicle ECU 22 carries out a control in the same way that the vehicle ECU 22 carries out the control when regeneration of the filter 44 is not carried out so that the same effects are obtained.

Specifically, in the region below the revolution speed N1, the output torque of the electric motor 6 is mainly controlled. This revolution region is corresponding to a start of the vehicle and the point which is defined by the revolution speed of the electric motor 6 and the required torque does not remain in this region over a long period. Consequently, it is regarded that this would not exert big influence on the regeneration of the filter 44 and priority is given to securing of the operating performance of the vehicle.

In the revolution region higher than the revolution speed N1, as shown in FIG. 3, the control region is divided into two regions, namely E2′ and M2′, and the boundary between the region E2′ and the region M2′ corresponds to the allowable torque of the engine 2. In the event that the required torque is included in the region E2′, as is the case of the region E2 in the control map of FIG. 2, the vehicle ECU 22 engages the clutch 4. At the same time, the vehicle ECU22 brings the output torque of the electric motor 6 to 0 N·m, and controls the electric motor 6 and the engine 2 so that the required torque is outputted by the engine 2 only.

In the event that the required torque is included in the region M2′, as is the case of the region M2 in the control map of FIG. 2, the vehicle ECU 22 engages the clutch 4. At the same time, the vehicle ECU 22 causes the engine 2 to output the allowable torque and causes the electric motor 6 to output the torque equal to the deficiency of the output torque of the engine 2 with respect to the required torque.

The chain line in FIG. 3 shows the boundary between the region E2 and the region M2 in the control map of FIG. 2. As shown in FIG. 3, in the revolution region lower than the revolution speed N2, the allowable torque when regeneration of the filter 44 is carried out is greater than the allowable torque when regeneration of the filter 44 is not carried out. On the other hand, in the revolution region higher than the revolution speed N2, the allowable torque when regeneration of the filter 44 is carried out is smaller than the allowable torque when regeneration of the filter 44 is not carried out.

As described before, in the revolution region higher than the revolution speed N1, the clutch 4 is engaged and the revolution speed of the electric motor 6 coincide with the revolution speed of the engine 2. Consequently, in the low revolution region of the engine 2 lower than the revolution speed N2, in the case in which regeneration of the filter 44 is carried out, the engine 2 can generate greater driving torque than that in the case in which regeneration of the filter 44 is not carried out.

Furthermore, in the high revolution region of the engine 2 higher than the revolution speed N2, in the case in which regeneration of the filter 44 is carried out, the output torque of the engine 2 is suppressed to be lower than that in the case in which generation of the filter 44 is not carried our. Consequently, as shown in FIG. 3, the output torque of the electric motor 6 increases that much in the case in which regeneration of the filter 44 is not carried out than in the case in which regeneration is carried out.

It is to be noted that, in the control map of FIG. 3, since the allowable torque is increased in the low revolution region of the engine 2 in this way, the sum of the allowable torque of the engine 2 and the upper limit torque of the electric motor 6 exceeds the upper limit value Tmax of the required torque in the region higher than the revolution speed N1. Consequently, the region such as region E3 of the control map of FIG. 2 is no longer required. In the event that the sum of the allowable torque of the engine 2 and the upper limit torque Tm of the electric motor 6 is short for the required torque even if the allowable torque is increased in the low revolution region of the engine 2 because of the characteristics of the engine 2 or the electric motor 6, a region corresponding to the region E3 of FIG. 2 may be provided in the control map which is used when the regeneration of the filter 44 is carried out. By so doing, even in such case, the operating performance of the vehicle can be properly secured.

When the filter 44 is regenerated, the engine 2 and the electric motor 6 are controlled at a start of the vehicle as follows. It is to be noted that, with respect to the control in the region below the revolution speed N1, it is the same as that when the regeneration of the filter 44 is not carried out and therefore the description will be omitted.

When the vehicle accelerates to achieve the traveling state after starting, the vehicle ECU 22 sets the required torque necessary for traveling of the vehicle in accordance with the depression amount of the accelerator pedal 30 detected by the accelerator pedal opening sensor 32 and the traveling speed detected by the vehicle speed sensor 34.

Since the revolution speed of the electric motor 6 is located in the region higher than the revolution speed N1, the vehicle ECU 22 changes over the control depending on which region of E2′ or M2′ of FIG. 3 the point defined by the revolution speed of the electric motor 6 detected by the revolution speed sensor 36 and the required torque is located.

In the event that the point defined by the revolution speed of the electric motor 6 and the required torque is located in the region E2′, the vehicle ECU 22 engages the clutch 4 and commands the inverter ECU 26 to bring the output torque of the electric motor 6 to 0 N·m. At the same time, the vehicle ECU 22 commands the engine ECU 24 so that the engine 2 outputs the required torque.

The inverter ECU 26 controls the inverter 20 to bring the output torque of the electric motor 6 to 0 N·m by operating the electric motor 6 neither as a motor nor as a generator. At the same time, the engine ECU 24 controls the engine 2 so that the engine 2 outputs the required torque. As a result, the required torque outputted from the engine 2 is transmitted to the transmission 8.

In the event that the point which is defined by the revolution speed of the electric motor 6 and the required torque is located in the region M2′, the vehicle ECU 22 engages the clutch 4 and commands the engine ECU 24 to bring the output torque of the engine 2 to the allowable torque. At the same time, the vehicle ECU 22 commands the inverter ECU 26 so that the electric motor 6 outputs the torque equal to the deficiency of the output torque of the engine 2 with respect to the required torque.

The engine ECU 24 controls the engine 2 so that the output torque of the engine 2 is equal to the allowable torque. At the same time, the inverter ECU 26 controls the inverter 20 so that the electric motor 6 is operated as a motor and the output torque of the electric motor 6 is equal to the torque directed by the vehicle ECU 22. As a result, the sum of the output torque of the engine 2 and the output torque of the electric motor 6, which is equal to the required torque, is transmitted to the transmission 8.

In this way, in the region in which the revolution speed of the electric motor 6, that is, the revolution speed of the engine 2 is higher than N1, the output torque of the engine 2 is restricted to the allowable torque or lower. In such event, in the low revolution region in which the revolution speed of the engine 2 is lower than N2, the allowable torque is set to be greater than that in the case in which regeneration of the filter 44 is not carried out. Consequently, the output of the engine 2 can be increase compared with the case in which regeneration of the filter 44 is not carried out. Consequently, the exhaust temperature of the engine 2 rises and it is possible to easily raise the exhaust temperature to the temperature required for regeneration of the filter 44. As a result, it is possible to prevent degradation of fuel economy due to an increase in fuel consumption rate for raising exhaust temperature and prolonged regeneration of the filter 44. In addition, it is possible to prevent defective regeneration of the filter 44 caused by short heating of the filter 44.

In the low revolution region, the output torque of the electric motor 6 decreases because of the increased allowable torque of the engine 2 in this way. Consequently, in the low revolution region, power consumption rate of the battery 18 by the electric motor 6 decreases. However, in the high revolution region in which the revolution speed of the engine 2 is higher than N2, the output torque of the engine 2 is restricted to the allowable torque smaller than that in the case in which regeneration of the filter 44 is not carried out. Accordingly, the output torque of the electric motor 6 increases that much and the power consumption of the battery 18 by the electric motor 6 increases.

Consequently, even if the power consumption of the electric motor 6 decreases in the low revolution region of the engine 2, SOC of the battery 18 can be maintained to a proper range and thereby deterioration of the battery 18 can be suppressed.

In this case, too, the output torque of the electric motor 6 compensates the deficiency from the required torque, which is caused by restricting the output torque of the engine 2 to the allowable torque. Accordingly, the required torque necessary for traveling of the vehicle is transmitted to the transmission 8. As a result, satisfactory operating performance of the vehicle can be secured without generating torque deficiency.

Controls for making the vehicle travel by transmitting the driving force of the engine 2 and the driving force of the electric motor 6 to driving wheels 16 through the transmission 8 is explained as above. On the other hand, in the event that the accelerator pedal 30 is released, the vehicle ECU 22 decelerate the vehicle with appropriate deceleration generated in the vehicle by the use of engine braking of the engine 2 and the regenerative braking force generated by the electric motor 6 which is operated as a generator. In such event, AC power obtained by the regenerative braking of the electric motor 6 is charged to the battery 18 after being converted into DC power by the inverter 20. By recovering the kinetic energy generated by the revolution of the driving wheels 16 as electric energy in this way, the energy efficiency of hybrid electric vehicle 1 is improved.

In the above, an embodiments of the control device for the hybrid electric vehicle according to the present invention have been described. The present invention is, however, not limited to the described embodiment. For example, in the embodiment, the electric motor 6 is disposed in between the clutch 4 and the transmission 8, but the disposition of the electric motor 6 is not limited to this. That is, as far as it is the hybrid electric vehicle in which the driving force of the engine 2 and the driving force of the electric motor 6 can be transmitted to driving wheels 16, respectively, for example, as is the case of the hybrid electric vehicle with the electric motor 6 disposed in between the engine 2 and the clutch 4, the same effect can be obtained by carrying out the control same as the above-mentioned embodiment in the region higher than the revolution speed N1 with the clutch 4 engaged.

In the above-mentioned embodiment, the revolution speed of the electric motor 6 detected by the revolution speed sensor 36 is used. However, the revolution speed may be obtained by converting the output revolution speed of the transmission 8 by the use of the gear ratio of the transmission 8, or the revolution speed of the electric motor 6 may be obtained from the amount which varies in accordance with the revolution speed of the electric motor 6.

In the above-mentioned embodiment, in the high-revolution region higher than the revolution speed N2, the allowable torque of the engine 2 is reduced in the case in which regeneration of the filter 44 is carried out from that in the case in which regeneration of the filter 44 is not carried out, while in the low revolution region lower than the revolution speed N2, the allowable torque of the engine 2 is increased in the case in which regeneration of the filter 44 is carried out from that in the case in which regeneration of the filter 44 is not carried out. However, the low revolution region and the high revolution region may be defined without using single revolution speed threshold value.

That is, a region lower than the first revolution speed may be designated as the low revolution region, and a region higher than the second revolution speed which is set to be higher than the first revolution speed may be designated as the high revolution region. In such event, in the low revolution region, the allowable torque of the engine 2 may be increased in the case in which regeneration of the filter 44 is carried out than in the case in which regeneration of the filter 44 is not carried out, while in the high revolution region, the allowable torque of the engine 2 may be decreased in the case in which regeneration of the filter 44 is carried out than in the case in which regeneration is not carried out.

In the above-mentioned embodiment, the engine 2 is a diesel engine, but the type of the engine is not limited to this, and it may be a gasoline engine, etc.

In the above-mentioned embodiment, the electric motor 6 is a permanent-magnetic synchronous motor, but the type of the electric motor is not limited to this.

In the above-mentioned embodiment, the transmission 8 is an automatic transmission, but the transmission type is not limited to this. For example, the transmission 8 may be a continuously variable transmission, a manual transmission, etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A control device for a hybrid electric vehicle arranged such that a driving force of an engine and a driving force of an electric motor can be transmitted to driving wheels, and that the engine and the electric motor are controlled on the basis of a required torque determined in accordance with an operating condition of the vehicle, comprising:
a filter that collects particulate matter contained in exhaust of the engine;
a regeneration means for incinerating the particulate matter collected and accumulated in the filter to regenerate the filter; and
a control means which, in the event that the driving force of the engine is transmitted to the driving wheels, controls the engine so that the required torque is outputted by the engine alone when the required torque is equal to or smaller than a predetermined allowable torque; and, on the other hand, controls the engine so that the engine outputs the allowable torque and, at the same time, controls the electric motor so that the electric motor outputs a torque equal to deficiency of the allowable torque with respect to the required torque when the required torque is greater than the allowable torque, wherein:
the control means increases the allowable torque in a lower revolution region of the engine, if the regeneration of the filter is carried out by the regeneration means, as compared to that when the regeneration of the filter is not carried out by the regeneration means, and decreases the allowable torque in a high revolution region of the engine.

2. The control device for a hybrid electric vehicle according to claim 1, further comprising a clutch that can cut off the transmission of the driving force from the engine to the driving wheels with the transmission of the driving force from the electric motor to the driving wheels maintained; and
in the event that the vehicle starts traveling, the control means disengages the clutch and controls the electric motor so that the electric motor outputs the required torque when the required torque is equal to or smaller than an upper limit torque that can be outputted from the electric motor at the present revolution speed of the electric motor, and, on the other hand, when the required torque is greater than the upper limit torque, the control means controls the clutch, the engine and the electric motor in such a manner that a sum of an output torque of the electric motor and a torque outputted from the clutch is equal to the required torque.

3. The control device for a hybrid electric vehicle according to claim 1, wherein:
the control means controls the electric motor so that the electric motor outputs an upper limit torque which can be outputted from the electric motor at the present revolution speed of the electric motor and increases an output torque of the engine from the allowable torque so that a sum of the output torque of the engine and an output torque of the electric motor equal to the required torque, in the event that the required torque is greater than the sum of the upper limit torque and the allowable torque.
